(19) United States
(12) Patent Application Publication
(10) Pub. No.: US 2007/0188957 A1
(43) Pub. Date: Aug. 16, 2007

(54) Energy transfer circuit having an electromagnetic induction device for utilizing energy stored by a snubber

(75) Inventors: Hsiang-Chung Weng, Taipei City (TW); Hsiang-Jui Hung, Taipei City (TW); Sun-Chen Yang, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTeK COMPUTER INC.

(21) Appl. No.: 11/585,132

(22) Filed: Oct. 24, 2006

(30) Foreign Application Priority Data
Feb. 14, 2006 (TW) 095104954

(51) Int. Cl. H02H 3/20; H02H 7/122

(52) U.S. Cl. 361/91.7; 363/56.05

(57) ABSTRACT

The invention relates to an energy transfer circuit. The energy transfer circuit has a first electromagnetic induction device, electrically connected to a first power supply node; a first switch circuit for connecting the first electromagnetic induction device and a second power supply node according to a first control signal; a snubber electrically connected between the first electromagnetic induction device and the second power supply node; a second electromagnetic induction device, coupled to the first electromagnetic induction device and electrically connected to the snubber and the second power supply node; and a third electromagnetic induction device coupled to the first and second electromagnetic induction devices and electrically connected to an output port of the energy transfer circuit.

### BACKGROUND OF THE INVENTION

1. Field of the Invention

The invention relates to an energy transfer circuit, and more particularly, to an energy transfer circuit capable of generating a wanted signal through utilizing a snubber to reduce power consumption and an electronic induction device to reuse energies stored inside the snubber.

2. Description of the Prior Art

A voltage converter is a necessary component in modern electronic products. Voltage converters are mainly utilized for adjusting the voltage inputted into an electronic product according to the required operational voltage of other components of the electronic product. For example, a normal hub operates with a 9V adapter. The 9V adapter is utilized to convert an AC voltage into a 9V DC voltage. Furthermore, because the operational voltage of an IC inside the hub is often 5V or 3V, a voltage converter should be set up inside the hub to convert the inputted 9V DC voltage into 5V or 3V voltage, which can then be utilized by the IC.

Please refer to FIG. 1, which is a diagram of a conventional voltage converter 10. As shown in FIG. 1, the voltage converter 10 is a flyback converter. The voltage converter 10 includes: a voltage source 12; two electronic induction devices 14, 16; a switch device 18; two diodes 28, 22; a capacitor 24; and a resistor 26. The switch device 18 is turned on according to a control signal Sc. As the control signal Sc is a periodical signal, the switch device 18 is also turned on periodically. When the switch device 18 is turned on, the voltage source 12, the electronic induction device 14, and the switch device 18 form a loop. At this time, one end (the node A) of the electronic induction device 14 is electrically connected to the voltage source, and the other end (the node B) is electrically connected to ground through the switch device 18. For the electronic induction devices 14 and 16, the node A and the node D correspond to the same polarization, and the node B and the node C correspond to the same polarization. Therefore, the voltage level of the node D is higher than that of the node C. The current cannot pass through the diode 28 because the diode 28 is not forward biased. In other words, when the switch device 18 is turned on, the power provided by the voltage source 12 is stored in the electronic induction device 14. When the switch device 18 is turned off, the current passing through the switch device 18 is reduced to zero. This means that the current passing through the electronic induction device 14 is similarly reduced to zero. Therefore, according to the theory of electronic induction reaction, the voltage level of the node D is lower than that of the node C such that the diode 28 becomes conductive. The electronic induction device 16 releases the power, which is previously provided by the voltage source 12, through the diode 18 to the load between nodes E and F. From the above, it can be seen that if the switch device 18 is repeatedly and periodically turned on and off, a steady output voltage between the node E and F can be provided. Furthermore, in the prior art, the electronic induction devices 14 and 16 are two induction coils of a transformer. The voltage converter 10 can therefore change the duty cycle of the switch device 18 and the ratio of turns of the electronic induction devices 14, 16 such that the output voltage Vo can be adjusted.

In an actual application, however, the switch device 18 is not an ideal device, and the electronic induction devices 14 and 16 have leakage inductance. At the time of switching the switch device 18 (this means the procedure where the switch device 18 is switched from a conductive state into a non-conductive state) and before the diode 28 is completely conductive, the above-mentioned leakage inductance generates a huge inducted voltage because the current reduces spontaneously. Furthermore, the inducted voltage generated by the leakage inductance, the inducted voltage generated by the electronic induction device 14, and the voltage Vᵢₙ provided by the voltage source 12 are series-connected such that an extreme voltage difference is formed on two ends of the switch device 18. The above-mentioned extreme voltage difference and the current, which reduces during the switching procedure of the switch device 18, consume a huge power, known as a turn off loss shown as the slope line region of FIG. 2. Please note that, in FIG. 2, I_{Q} represents the current passing through the switch device 18, V_{Q} represents the voltage difference on the two ends of the switch device 18, and the area of the slope line region is equal to the product of I_{Q} and V_{Q}. Therefore, the conventional voltage converter 10 further includes a diode 22, a capacitor 24, and a resistor 26. In the procedure of switching the switch device 18 from the conductive state into the non-conductive state, the voltage difference on the two ends of the switch device 18 turns on the diode 22. Therefore, the diode 22 and the capacitor 24 form another current path to obtain currents such that the capacitor 24 is charged. In other words, the capacitor 24 can reduce the variance of the voltage difference V_{Q} on the two ends of the switch device 18, decreasing the turn off loss. In addition, after the switch device 18 is turned on, the diode 22 cannot be forward biased. At this time, the energies stored in the capacitor 24 are consumed by the resistor 26.

From the above disclosure, for the conventional voltage converter 10, the power stored inside the capacitor 24 is consumed by the resistor instead of being utilized. Therefore, the utilization rate of the power of the conventional voltage converter 10 is not good.

### SUMMARY OF THE INVENTION

It is therefore one of the primary objectives of the claimed invention to provide a energy transfer circuit capable of generating a wanted signal through utilizing a snubber to reduce power consumption and utilizing an electronic induction device to reuse energies stored inside the snubber, to solve the above-mentioned problem.

According to an exemplary embodiment of the claimed invention, an energy transfer circuit is disclosed. The energy transfer circuit comprises: a first electronic induction device comprising a first end and a second end, wherein the first end of the first electronic induction device is electrically connected to a first power supply node; a first switch device, electrically connected to the second end of the first electronic induction device, for selectively establishing an electrical connection between the second end of the first electronic induction device and a second power supply node according to a first control signal; a snubber, electrically connected between the second end of the first electronic induction device and the second power supply node; a second electronic induction device, coupled to the first electronic induction device, the second electronic induction device comprising a first end and a second end, wherein the first end of the second electronic induction device is electrically connected to the snubber, and the second end of the second electronic induction device is electrically connected to the second power supply node; and a third electronic induction device, coupled to the first electronic induction device and the second electronic induction device, the third electronic induction device comprising a first end and a second end, wherein the second end of the third electronic induction device is electrically connected to an output port of the energy transfer circuit.

According to another exemplary embodiment of the claimed invention, a energy transfer circuit is disclosed. The energy transfer circuit comprises: a first electronic induction device, comprising a first end and a second end, wherein the first end of the first electronic induction device is electrically connected to a first power supply node; a first switch device, electrically connected to the second end of the first electronic induction device, for selectively establishing an electrical connection between the second end of the first electronic induction device and a second power supply node according to a first control signal; a snubber, electrically connected between the second end of the first electronic induction device and the second power supply node; a second electronic induction device, comprising a first end and a second end, wherein the first end of the second electronic induction device is electrically connected to the snubber, and the second end of the second electronic induction device is electrically connected to the second power supply node; a third electronic induction device, coupled to the first electronic induction device, the third electronic induction device comprising a first end and a second end, wherein the second end of the third electronic induction device is electrically connected to a first output port of the energy transfer circuit; and a fourth electronic induction device, coupled to the second electronic induction device, the fourth electronic induction device comprising a first end and a second end, wherein the second end of the fourth electronic induction device is electrically connected to a second output port of the energy transfer circuit.

The present invention power converter can utilize a snubber to reduce the turn off loss during the procedure of switching the switch devices, and feedback the energies stored in the snubber to another electronic induction device in order to generate wanted signals. Therefore, the present invention power converter can have a better power utilization rate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional voltage converter 10.

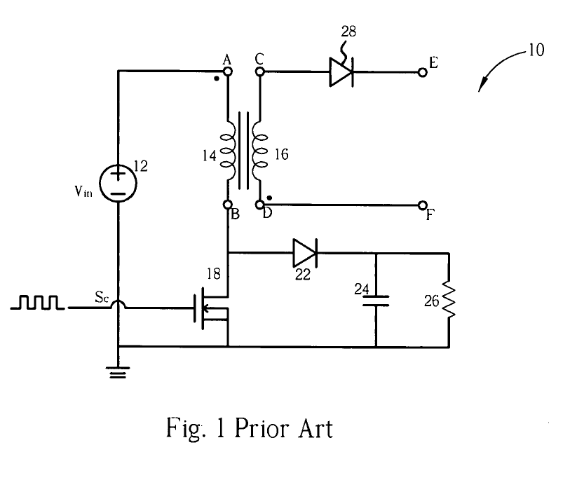

FIG. 2 is a diagram illustrating turn off loss according to the prior art.

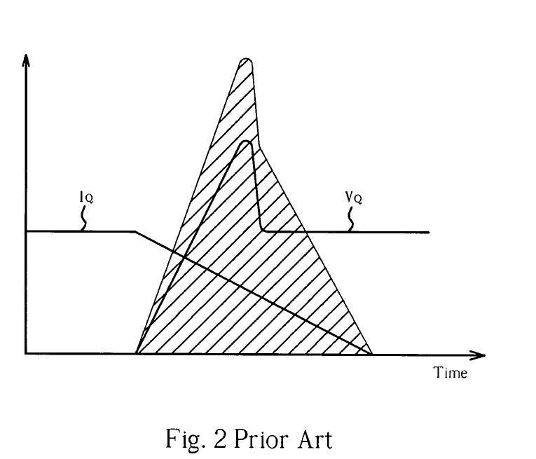

FIG. 3 is a diagram of a power converter of a first embodiment according to the present invention.

FIG. 4 is a diagram of a snubber shown in FIG. 3 of an embodiment according to the present invention.

FIG. 5 is a diagram of an output module shown in FIG. 3 of a first embodiment according to the present invention.

FIG. 6 is a diagram of an output module shown in FIG. 3 of a second embodiment according to the present invention.

FIG. 7 is a diagram of an output module shown in FIG. 3 of a third embodiment according to the present invention.

FIG. 8 is a diagram illustrating the turn off loss of the power converter according to the present invention.

FIG. 9 is a diagram of a power converter of a second embodiment according to the present invention.

### DETAILED DESCRIPTION

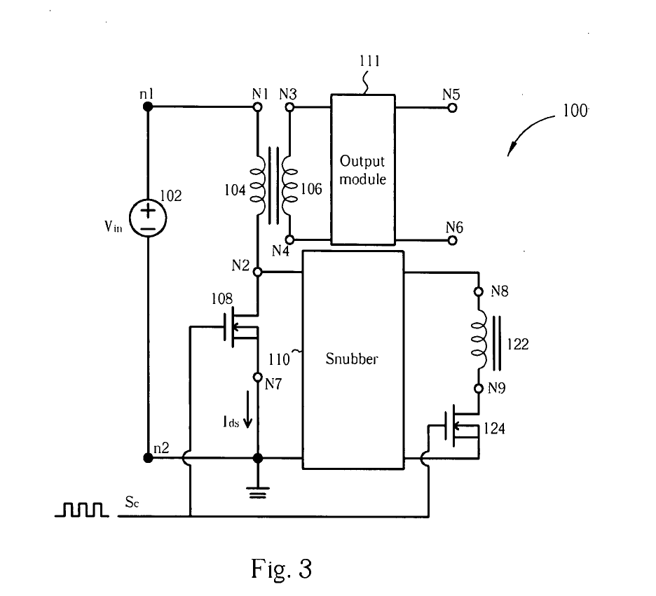

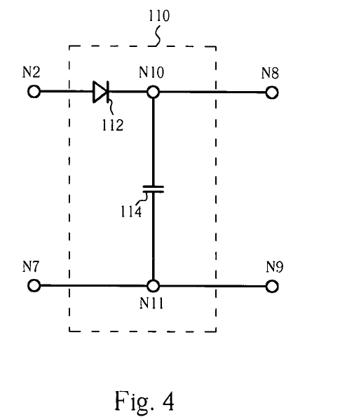

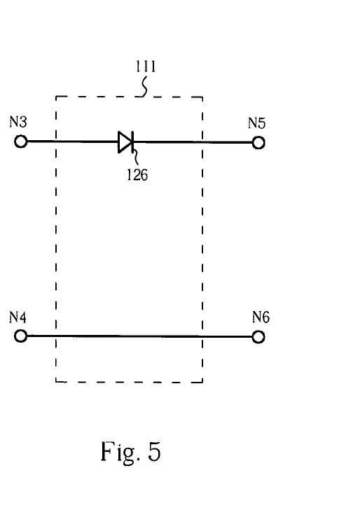

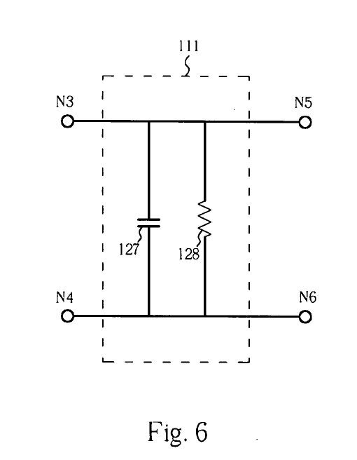

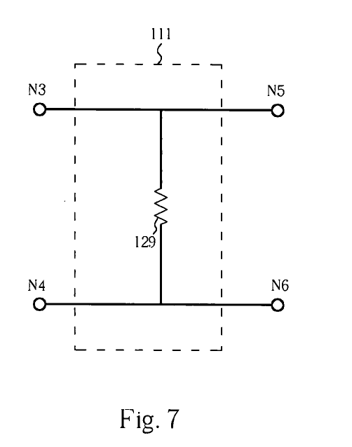

Please refer to FIG. 3, which is a diagram of a power converter 100 of a first embodiment according to the present invention. In this embodiment, the power converter 100 includes a voltage source 102, a plurality of electronic induction devices 104, 106, and 122, a plurality of switch devices 108 and 124, a snubber 110, and an output module 111. The snubber 110 is utilized to reduce the power consumption (the turn off loss) of switching the switch device 108 from the conductive state into the non-conductive state. As shown in FIG. 4, in an embodiment, the snubber 1 10 can be formed by a diode 112 and a capacitor 114 (coupled between the node N10 and N11). Please note that the circuit of the snubber 110 is only utilized as an embodiment, not a limitation of the present invention. In this embodiment, the output module 111 is utilized to generate a wanted signal according to the voltage difference between the node N3 and the node N4, which is established by the electronic device 106. The output module 111 outputs the signal to the following circuit through the nodes N5 and N6. Furthermore, the output module 111 can have different circuit structures according to different design demands (e.g. DC output or AC output) of the power converter 100. As shown in FIG. 5, a first embodiment of the output module 111 can be formed by a diode 126, which is used as a commuter to make the voltage level of the node N5 always larger than the voltage level of the node N6. That is, the power converter 100 shown in FIG. 5 can be utilized to output DC signals to the following circuits. In addition, as shown in FIG. 6, a second embodiment of the output module 111 can be formed by a capacitor 127 and a resistor 128, for performing a waveform adjustment. For example, if the voltage between the nodes N3 and N4 corresponds to a square wave, the voltage between the nodes N5 and N6 corresponds to a sine wave. Moreover, as shown in FIG. 7, a third embodiment of the output module 111 can be formed by a resistor 129. At this time, the output module 111 can be regarded as a loading, and have no waveform adjustment or current commutation functions. That is, if the voltage between the nodes N3 and N4 corresponds to a square wave, the voltage between the nodes N5 and N6 corresponds to a square wave too. Similarly, please note that the circuit structures of the output module 111 shown in FIGS. 5-7 are only utilized as embodiments, and not limitations of the present invention.

The electronic induction device 122 is utilized for reusing the energies stored inside the snubber, in order to raise the power utilization rate. In order to clearly illustrate the function and the operation of the electronic induction device 122, the power converter 100 is utilized as an application of a flyback converter for an illustration. In addition, the output module 111 shown in FIG. 3 is implemented as the circuit structure shown in FIG. 5. The snubber 110 shown in FIG. 3 is implemented as the circuit structure shown in FIG. 4. The nodes N1, N4, and N8 correspond to the same polarization, and the nodes N2, N3, and N9 correspond to another polarization.

The power converter 100 output a predetermined DC voltage through the nodes N5 and N6 for an external circuit (not shown) to use. As shown in FIG. 3, the control signal Sc is utilized to simultaneously control the switch devices 108 and 124. When the switch device 108 is turned on to be conductive, the voltage source 102 provides a current from the power supply node n1 into the electronic induction device 104 and the switch device 108, and finally flows to ground through the power supply node n2. At this time, the two ends of the electronic induction device 104 have a voltage difference V1, which is almost equal to the input voltage Vᵢₙ of the voltage source 102. Because the switch device 108 connects one end of the electronic induction device 104 to ground, the diode 112 (shown in FIG. 4) is not conductive because the diode is not forward biased. This means that there is no current passing through the diode 112. Moreover, from the above illustration of the conventional voltage converter 10, it is easily seen that there is no current passing thorough the diode 126 inside the output module 111.

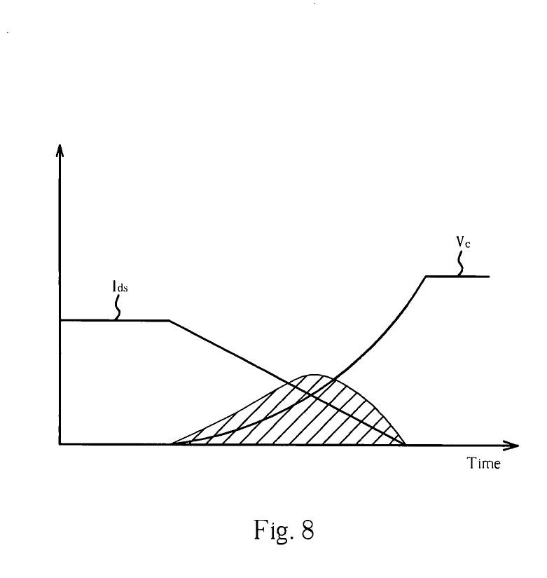

Furthermore, from the above illustration of the conventional voltage converter 10, during the procedure of switching the switch device 108 from the conductive state into the non-conductive state, when the diode 126 (shown in FIG. 5) is not completely conductive, the current passing through the electronic induction device 104 is inputted to the capacitor 114 of the snubber 110 through the diode 112. Therefore, the energies carried by the current are stored inside the capacitor 114. Because the voltage between the node N10 and N11 of the capacitor 114 (the voltage between the nodes N2 and N7 of the switch device 108) rises slowly, the turn off loss caused by the switch device 108 can be reduced. Please note that, in FIG. 8, I_{ds} represents the current passing through the switch device 108, V_{c} represents the voltage between the two ends of the capacitor 114, and the area of the slope line region represents the product of I_{ds} and V_{c}.

When the switch devices 108 and 124 are tuned on again, the diode 112 becomes non-conductive. Therefore, the capacitor 114 and the electronic induction device 112 form a current path. At this time, the energies stored inside the capacitor 114 are transferred to the electronic induction device 122 such that a voltage is established between the two ends of the electronic induction device 122. Because the electronic induction device 122 and the electronic induction devices 104 and 106 are coupled, when the diode 126 is conductive, the energies stored inside the electronic induction device 122 are also coupled to the electronic induction device 104. That is, the electronic induction device 106 generates an inducted voltage according to the electronic induction devices 104 and 122, and the amplitude of the inducted voltage is related to the turn ratio among the electronic induction devices (field inductors) and the duty cycle of the switch devices 108 and 124. In other words, the present invention can control the output DC voltage through setting the turns of the electronic devices 104, 106, and 122, and the duty cycle of the control signal Sc.

From the above disclosure, when the control signal Sc periodically changes its state, the voltage source 12 repeatedly charges the electronic induction device 104, the snubber 110 also periodically absorbs the turn off loss of the switch device 108, and the electronic induction device 122 further reuses the energy absorbed by the snubber 110 such that the efficiency of the voltage converter can be raised. Please note that, in this embodiment, the electronic induction devices 104, 106, and 122 are composed of at least one induction coil. In order to have better efficiency, the electronic induction device 104, 106, and 112 can share the same iron core (obviously, the core can be formed by other conductors). Therefore, the electronic induction devices 104, 106, and 122 can be regarded as a voltage transformer. In addition, the present invention power converter 100 can be utilized not only in an application of a flyback converter, but also in a forward converter, an isolated converter, or other power converters in the form of a voltage transformer. For example, users can determine the corresponding relationships of the polarizations of the nodes N1, N2, N3, N4, N8, and N9 such that the voltage converter can have different configurations.

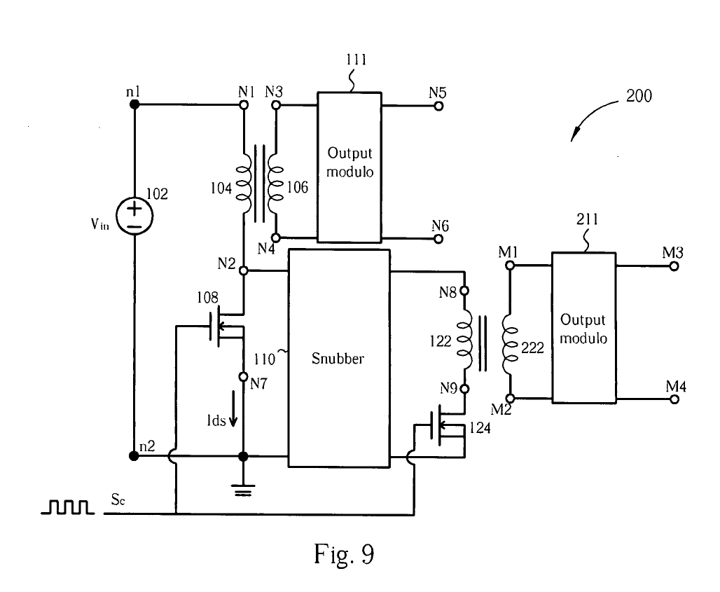

Please refer to FIG. 9, which is a diagram of a power converter 200 of a second embodiment according to the present invention. The power converter 200 shown in FIG. 9 is similar to the power converter 100 shown in FIG. 3. The main difference between the power converter 100 and the power converter 200 is that the power converter 200 further includes an electronic induction device 222 and an output module 211. Please note that the operation and the function of the other components inside the power converter 200 have been illustrated in the above disclosure, and are thus omitted here. In addition, the electronic induction device 122 is coupled with the electronic induction device 222 instead of the electronic induction devices 104 and 106 shown in FIG. 3. Therefore, the energies stored inside the electronic induction device 122 are transferred back to the electronic induction device 222 (in this embodiment, the electronic induction devices 122 and 222 form a voltage transformer, and the electronic induction devices 104 and 106 form another voltage transformer). The output module 211 then generates wanted signals according to the voltage difference between the nodes Ml and M2 of the electronic induction device 222, and outputs the signals to the following circuit. In this embodiment, the output module 211 can be implemented by the circuit structures shown in FIGS. 5-7. Please note that, in the power converter 200, the circuit structure of the output module 211 is not limited to the circuit structures shown in FIGS. 5-7. In addition, because the energies stored inside the electronic induction device 122 are not transferred to the electronic induction device 106, the power converter 200 can establish another output signal (an AC signal or a DC signal) through utilizing the electronic induction device 222. For example, the output module 111 is utilized to provide a 5V DC voltage and the output module 211 can be utilized to provide a 3V DC voltage.

In contrast to the prior art, the present invention power converter can utilize a snubber to reduce the turn off loss during the procedure of switching the switch devices, and feedback the energies stored in the snubber to another electronic induction device in order to generate wanted signals. Therefore, the present invention power converter can have a better power utilization rate.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An energy transfer circuit comprising:
a first electronic induction device comprising a first end and a second end, wherein the first end of the first electronic induction device is electrically connected to a first power supply node;
a first switch device, electrically connected to the second end of the first electronic induction device, for selectively establishing an electrical connection between the second end of the first electronic induction device and a second power supply node according to a first control signal;
a snubber, electrically connected between the second end of the first electronic induction device and the second power supply node;
a second electronic induction device, coupled to the first electronic induction device, the second electronic induction device comprising a first end and a second end, wherein the first end of the second electronic induction device is electrically connected to the snubber, and the second end of the second electronic induction device is electrically connected to the second power supply node; and
a third electronic induction device, coupled to the first electronic induction device and the second electronic induction device, the third electronic induction device comprising a first end and a second end, wherein the second end of the third electronic induction device is electrically connected to an output port of the energy transfer circuit.

2. The energy transfer circuit of claim 1, further comprising:
a second switch device, electrically connected between the second end of the second electronic induction device and the second power supply node, for selectively establishing an electrical connection between the second end and the second power supply node according to a second control signal.

3. The energy transfer circuit of claim 2, wherein the first control signal is synchronized with the second control signal for simultaneously turning on/off the first switch device.

4. The energy transfer signal of claim 1, wherein each of the first electronic induction device, the second electronic induction device, and the third electronic induction device comprises at least one induction coil.

5. The energy transfer circuit of claim 4, wherein the first electronic induction device, the second electronic induction device, and the third electronic induction are coiled on a same conductor.

6. The energy transfer circuit of claim 1, having a forward converter configuration.

7. The energy transfer circuit of claim 1, having a flyback converter configuration.

8. The energy transfer circuit of claim 1, having an isolated converter configuration.

9. An energy transfer circuit comprising:
a first electronic induction device, comprising a first end and a second end, wherein the first end of the first electronic induction device is electrically connected to a first power supply node;
a first switch device, electrically connected to the second end of the first electronic induction device, for selectively establishing an electrical connection between the second end of the first electronic induction device and a second power supply node according to a first control signal;
a snubber, electrically connected between the second end of the first electronic induction device and the second power supply node;
a second electronic induction device, comprising a first end and a second end, wherein the first end of the second electronic induction device is electrically connected to the snubber, and the second end of the second electronic induction device is electrically connected to the second power supply node;
a third electronic induction device, coupled to the first electronic induction device, the third electronic induction device comprising a first end and a second end, wherein the second end of the third electronic induction device is electrically connected to a first output port of the energy transfer circuit; and
a fourth electronic induction device, coupled to the second electronic induction device, the fourth electronic induction device comprising a first end and a second end, wherein the second end of the fourth electronic induction device is electrically connected to a second output port of the energy transfer circuit.

10. The energy transfer circuit of claim 9, further comprising:
a second switch device, electrically connected between the second end of the second electronic induction device and the second power supply node, for selectively establishing an electrical connection between the second end of the second electronic induction device and the second power supply node according to a second control signal.

11. The energy transfer circuit of claim 10, wherein the first control signal is synchronized with the second control signal for simultaneously turning on/off the first switch device and the second switch device.

12. The energy transfer circuit of claim 9, wherein each of the first electronic induction device, the second electronic induction device, the third electronic induction device, and the fourth electronic induction device comprises at least one induction coil.

13. The energy transfer circuit of claim 9, having a forward converter configuration.

14. The energy transfer circuit of claim 9, having a flyback converter configuration.

15. The energy transfer circuit of claim 9, having an isolated converter configuration.
